(19) United States
(12) Patent Application Publication
(10) Pub. No.: US 2002/0120686 A1
(43) Pub. Date: Aug. 29, 2002

(54) System and method for establishing a plurality of collaboration connections between a customer and a seller

(75) Inventors: Charles E. Schell, III, Churchville, PA (US); Jeffrey D. Ollis, Harleysville, PA (US)

Correspondence Address: Daniel H. Golub, Morgan, Lewis & Bockius LLP, 1701 Market Street, Philadelphia, PA, 19103-2921, US

(73) Assignee: General Instrument Corporation

(21) Appl. No.: 09/793,227

(22) Filed: Feb. 26, 2001

(51) Int. Cl. G06F 15/16; G06F 17/60

(52) U.S. Cl. 709/204; 705/1

(57) ABSTRACT

The present invention is a system for establishing a plurality of collaboration connections between a customer and a seller. Each of the collaboration connections uses a different media for communication between the customer and the seller. The system includes an option for the customer to initiate contact with a representative of the seller, on a web page associated with the seller. The system further includes, a signal received at a web server of the seller indicating that the customer viewing the web page has opted to initiate contact with the representative of the seller. The signal also includes a network address and a telephone number of the customer.

The system additionally includes, a voice connection established in response to receipt of the signal at the web server between the representative of the seller and the customer. The voice connection is established by dialing from a telephone coupled to the web server of the seller, the telephone number of the customer. An interactive connection is established in response to receipt of the signal at the web server between the representative of the seller and the customer over a computer network using an applet that has been downloaded to a computer at the network address of the customer. The applet enables the representative of the seller and the customer to simultaneously interact with a commonly accessible web page. The voice connection and the interactive connection are simultaneously maintained during a time period after the voice connection and interactive connection are established. At least two different media are used in collaboration between the representative of the seller and the customer after the voice connection and interactive connection have been maintained. The present invention also provides a method for establishing a plurality of collaboration connections between a customer and a seller.

### FIELD OF THE INVENTION

The present invention relates to a communication system and more particularly, to a communication system for establishing a plurality of collaboration connections between a buyer and a seller.

### BACKGROUND OF THE INVENTION

It is well known that the “Internet” is a worldwide-interconnected network of computers, access to which may be had for purposes of communication, research, entertainment, shopping and the like. It is also known that through the implementation of IP Telephony, voice, data, and multimedia service connections may be established over high-speed networks such as the internet. It would be beneficial to provide a system and method that allows a customer and a representative of a seller to establish a voice connection and interactive connection on a web page of the seller over the Internet in order to collaborate with each other.

### BRIEF SUMMARY OF THE INVENTION

Briefly, the present invention provides a system for establishing a plurality of collaboration connections between a customer and a seller. Each of the collaboration connections uses a different media for communication between the customer and the seller. The system comprises, a web server that presents, on a web page associated with the seller, an option for the customer to initiate contact with a representative of the seller. The web server receives a signal indicating that the customer viewing the web page has opted to initiate contact with a representative of the seller. The signal includes a network address and a telephone number of the customer.

The system additionally comprises a telephony controller that is coupled to the web server. The telephony controller establishes in response to receipt of the signal at the web server, a voice connection between the representative of the seller and the customer. The voice connection is established by dialing from a telephone coupled to the web server of the seller, the telephone number of the customer. The web server establishes, in response to receipt of the signal at the web server, an interactive connection between the representative of the seller and the customer over a computer network using an applet that has been downloaded to a computer at the network address of the customer. The applet enables the representative of the seller and the customer to simultaneously interact with a commonly accessible web page. The web server and telephony controller maintain voice connection and the interactive connection simultaneously during a time period after the voice connection and interactive connection are established. This permits at least two different media to be used for collaborations between the representative of the seller and the customer after the voice connection and interactive connection have been established.

The present invention also includes a method for establishing a plurality of collaboration connections between a customer and a seller. Each of the collaboration connections uses a different media for conununications between the customer and the seller. The method comprises a first step that includes, presenting, on a web page associated with the seller, an option for the customer to initiate contact with a representative of the seller. The method further comprises a second step that includes, receiving, at a web server of the seller, a signal indicating that the customer viewing the web page has opted to initiate contact with the representative of the seller, and a network address and a telephone number of the customer.

The method additionally comprises, establishing, in response to receipt of the signal at the web server, a voice connection between the representative of the seller and the customer by dialing, from a telephone coupled to the web server of the seller, the telephone number of the customer. The method also comprises, establishing, in response to receipt of the signal at the web server, an interactive connection between the representative of the seller and the customer over a computer network using an applet that has been downloaded to a computer at the network address of the customer. The applet enables the representative of the seller and the customer to simultaneously interact with a commonly accessible web page.

The method further includes, maintaining the voice connection and the interactive connection simultaneously during a time period after the steps of establishing the voice connection and interactive connection are established. The representative of the seller and the customer collaborate using at least two different media during the collaboration step, while the voice connection and interactive connection are maintained.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the futures of the invention. In the drawings:

FIG. 1 is a plan view of a first embodiment of the communication system of the present invention;

FIG. 2 is a plan view of a second embodiment of the communication system of the present invention;

FIG. 3 is a plan view of a third embodiment of the communication system of the present invention;

FIG. 4 is a plan view of a fourth embodiment of the communication system of the present invention; and

FIG. 5 is a flow chart illustrating the sequence of method in establishing a plurality of collaboration connections between a customer and a seller.

### DETAILED DESCRIPTION OF THE PREFERRED EMBODIMENT

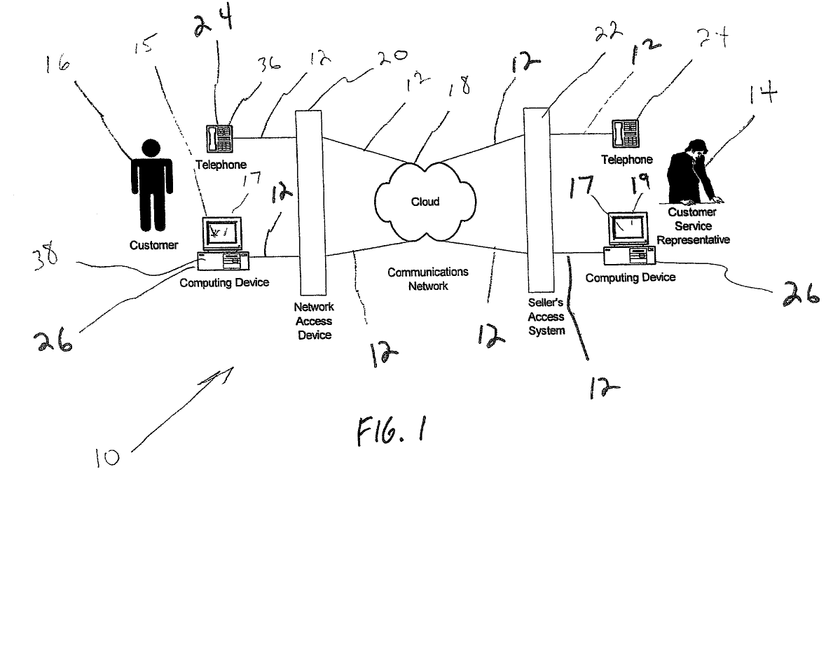

There is shown in FIG. 1, a communication system 10 according to a first embodiment of the present invention. The communication system 10 comprises a plurality of collaboration connections 12 established between a customer 16 and a representative of the seller 14. The system 10 further comprises a computer network 18, a customer's network access device 20, and a seller's access system 22. The customer's network access device 20 and seller's access system 22, enable collaboration between the customer 16 and the representative of the seller 14 over the computer network 18.

The system 10 additionally comprises a plurality of telephones 24 for establishing a voice connection between the customer 16 and the representative of the seller 14. The voice connection established between the customer 16 and the representative of the seller 14 are connected by the plurality of collaboration connections 12 linked between the customers network access device 20, the computer network 18, and the sellers access system 22. The system 10 also includes a plurality of computing devices 26 for establishing an interactive connection between the customer 16 and the representative of the seller 14. The interactive connection that is established between the customer 16 and the representative of the seller 14 are connected by the plurality of collaboration connections 12 linked between the customers network access device 20, the computer network 18, and the seller's access system 22.

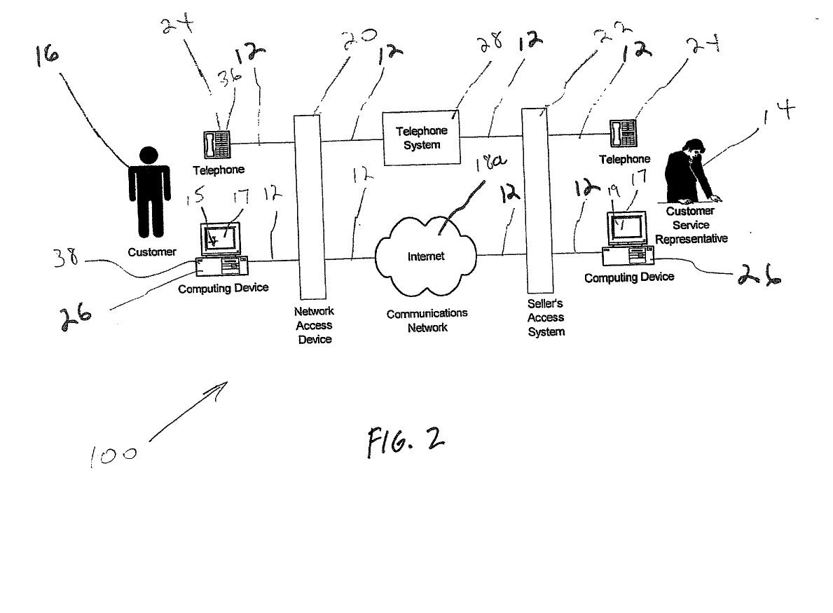

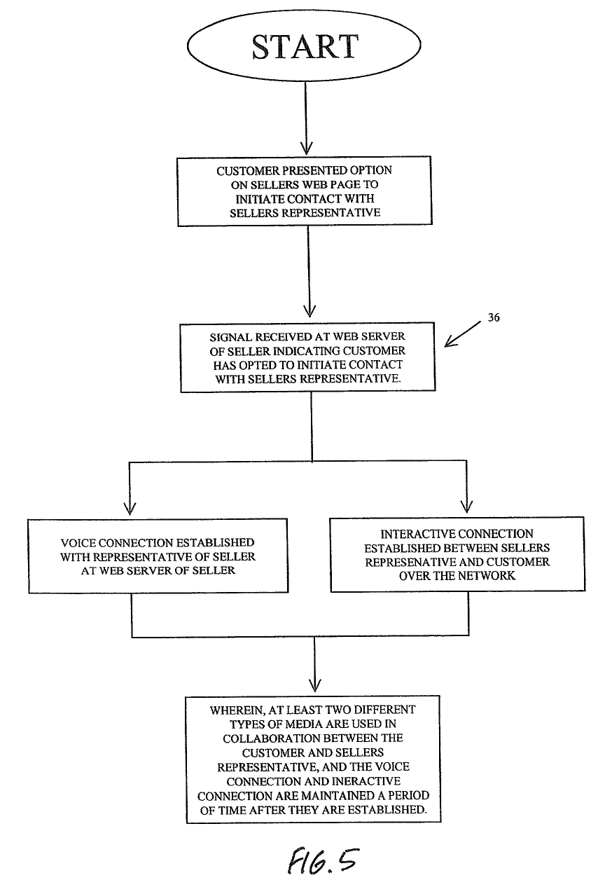

Referring now to FIG. 5, there is shown a flow chart 36. The flow chart 36, when viewed together with FIG. 1 (or, alternatively, FIGS. 2-4), illustrates a method of establishing the plurality of collaboration connections 12 between the customer 16 and the seller 14. In the method, an option in the form of a button 15 is presented to the customer 12, on a web page 17 associated with the seller 14. The button 15 and web page 17 are displayed on the computing device 26 of the customer 16. The button 15, when selected by the customer 12 initiates contact with the representative of the seller 14. In response to the initiation of the button 15 by the customer 16 on the web page 17 of the seller 14, a signal 19 is received at the access system 22 of the seller 14. The signal 19 indicates that the customer 16 viewing the web page 17 has opted to initiate contact with the representative of the seller 14. The signal 19 also includes a network address 38 and telephone number 36 of the customer 16.

After receipt of the signal 19 at the seller's access system 22, the seller's access system 22 selects and sends an alert to an available representative of the seller 14. The seller's access system 22 then places a call to the customer 16 using telephone number 36. In the embodiment of FIG. 1, the call is transmitted over the computer network 18 (e.g., the internet) using, for example, voice over ip telephony. When the customer 16 answers the telephone 24, the seller's access system 22 connects the representative of the seller 14 to the customer 16. The customer 16 and the representative of the seller 14 are now in voice contact. At or about the same time the voice connection is being established, the seller's access system 22 is establishing an interactive connection. The seller's access system 22 uses an applet that has been downloaded to the computing device 26 at the network address 38 of the customer 16, to enable the representative of the seller 14 and customer 16 to interact simultaneously with the commonly accessible web page 17. The customer 16 and representative of the seller 14 are now in a collaborative mode. Questions and answers can move in either direction from the customer 16 to the seller 14 and from the seller 14 to the customer 16 over either the telephone connection, the interactive connection (i.e., the commonly accessible web page), or both.

Referring now to FIG. 2, there is shown a second embodiment of the communication system 100 of the present invention. The communication system 100 is identical to the system 10 described above in the first embodiment, with the exception, that the voice connection established between the customer 16 and the representative of the seller 14 is connected through a public switched telephone system 28 rather than through the computer network 18.

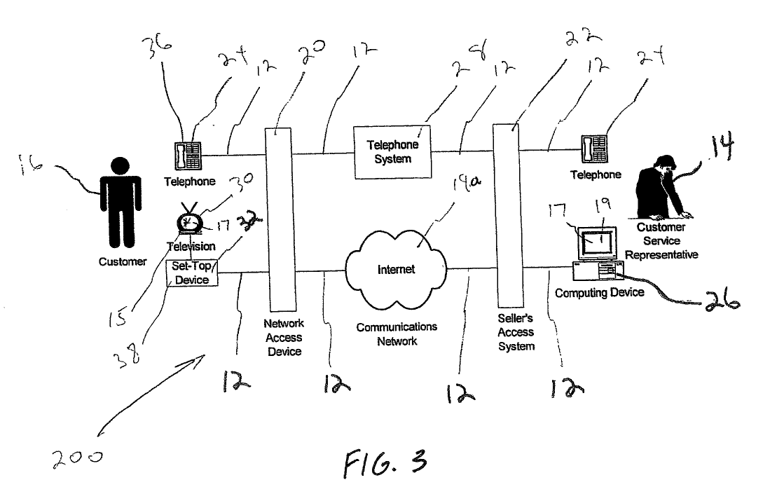

Referring now to FIG. 3, there is shown a third embodiment of the communication system 200 of the present invention. The communication system 200 is identical to system 100 described above in the second embodiment, with the exception. that the interactive connection is initiated from a television 30 connected to a set top device 32 rather than through the computing device 26. Set top box 32 includes hardware/software that enable customer 16 to access the internet 18a on television 30.

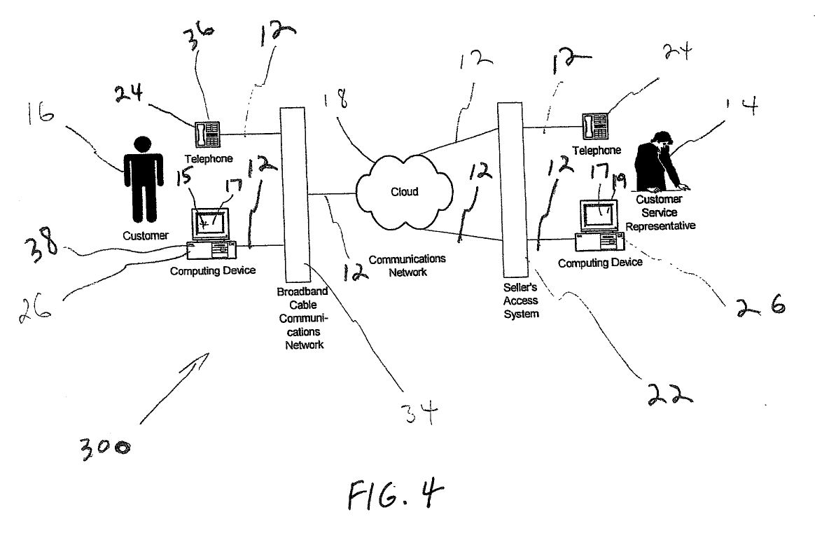

Referring now to FIG. 4, there is shown a fourth embodiment of the communication system 300 of the present invention. The communication system 300 is identical to communication system 10 as described above in the first embodiment, with the exception that a broadband cable communications network 34 connects the customer's 16 telephone 24 and computing device 26 to the computer network 18.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed:

1. A method for establishing a plurality of collaboration connections between a customer and a seller, wherein each of the collaboration connections uses a different media for communications between the customer and the seller, comprising the steps of:
(A) presenting, on a web page associated with the seller, an option for the customer to initiate contact with a representative of the seller;
(B) receiving, at a web server of the seller, a signal indicating that the customer viewing the web page has opted to initiate contact with the representative of the seller, and a network address and a telephone number of the customer;
(C) establishing, in response to receipt of the signal at the web server, a voice connection between the representative of the seller and the customer by dialing, from a telephone coupled to the web server of the seller, the telephone number of the customer;
(D) establishing, in response to receipt of the signal at the web server, an interactive connection between the representative of the seller and the customer over a computer network using an applet that has been downloaded to a computer at the network address of the customer, wherein the applet enables the representative of the seller and the customer to simultaneously interact with a commonly accessible web page; and
(E) maintaining the voice connection and the interactive connection simultaneously during a time period after steps (C) and (D) are completed;
wherein the representative of the seller and the customer collaborate using at least two different media during step (E).

2. The method of claim 1, wherein the voice connection is established over a public switched telephone network in step (C) and the interactive connection is established over the internet in step (D).

3. The method of claim 1 or 2, wherein the web page presented in step (A) is presented on a television of the customer via a web-enabled appliance coupled to the television.

4. The method of claim 1, 2 or 3 wherein the voice connection and the interactive connection are both established over the internet and a common broadband cable communications network.

5. An apparatus for establishing a plurality of collaboration connections between a customer and a seller, wherein each of the collaboration connections uses a different media for communications between the customer and the seller, comprising:
a web server that presents, on a web page associated with the seller, an option for the customer to initiate contact with a representative of the seller;
wherein the web server receives a signal indicating that the customer viewing the web page has opted to initiate contact with a representative of the seller, the signal including a network address and a telephone number of the customer;
a telephony controller, coupled to the web server, that establishes, in response to receipt of the signal at the web server, a voice connection between the representative of the seller and the customer, the voice connection being established by dialing from a telephone coupled to the web server of the seller, the telephone number of the customer;
wherein the web server establishes, in response to receipt of the signal at the web server, an interactive connection between the representative of the seller and the customer over a computer network using an applet that has been downloaded to a computer at the network address of the customer, the applet enabling the representative of the seller and the customer to simultaneously interact with a commonly accessible web page; and
wherein the web server and telephony controller maintain voice connection and the interactive connection simultaneously during a time period after the voice connection and interactive connection are established so as to permit at least two different media to be used for collaborations between the representative of the seller and the customer after the voice connection and interactive connection have been established.

6. The apparatus of claim 5, wherein the voice connection is established over a public switched telephone network in step (C) and the interactive connection is established over the internet in step (D).

7. The apparatus of claim 5 or 6, wherein the web page presented in step (A) is presented on a television of the customer via a web-enabled appliance coupled to the television.

8. The apparatus of claim 5, 6 or 7 wherein the voice connection and the interactive connection are both established over the internet and over a common broadband cable communications network.

9. A computer readable medium having stored thereon instructions for establishing a plurality of collaboration connections between a customer and a seller, wherein each of the collaboration connections uses a different media for communications between the customer and the seller, wherein the instructions, when executed by a processor, cause the processor to:
present, on a web page associated with the seller, an option for the customer to initiate contact with a representative of the seller;
receive, at a web server of the seller, a signal indicating that the customer viewing the web page has opted to initiate contact with the representative of the seller, and a network address and a telephone number of the customer;
establish, in response to receipt of the signal at the web server, a voice connection between the representative of the seller and the customer by dialing, from a telephone coupled to the web server of the seller, the telephone number of the customer;
establish, in response to receipt of the signal at the web server, an interactive connection between the representative of the seller and the customer over a computer network using an applet that has been downloaded to a computer at the network address of the customer, wherein the applet enables the representative of the seller and the customer to simultaneously interact with a commonly accessible web page;
maintain the voice connection and the interactive connection simultaneously during a time period after the voice connection and interactive connection are established; and
wherein the representative of the seller and the customer collaborate using at least two different media after the voice connection and interactive connection are established.
